(19) United States
(12) Patent Application Publication
(10) Pub. No.: US 2026/0133550 A1
(43) Pub. Date: May 14, 2026

(54) CENTRALIZED CONTROL OF DISTRIBUTED COMPUTING DEVICE COOLING COMPONENTS

(71) Applicant: Juniper Networks, Inc., Sunnyvale, CA (US)

(72) Inventors: Raja Kommula, Cupertino, CA (US); Ganesh Byagoti Matad Sunkada, Bengaluru (IN); Thayumanavan Sridhar, Sunnyvale, CA (US); Prammanayagam Mandramoorthy, Bangalore (IN); Vinamra Jaiswal, Bangalore (IN); Rahamath Sharif, Bangalore (IN); Rajendra Shivaram Yavatkar, Los Gatos, CA (US)

(21) Appl. No.: 19/384,364

(22) Filed: Nov. 10, 2025

(30) Foreign Application Priority Data
Nov. 9, 2024 (IN) 202441086403

(51) Int. Cl. G05B 13/04; G05B 13/02; G06F 1/20

(52) U.S. Cl. CPC G05B 13/048; G05B 13/0265; G06F 1/206

(57) ABSTRACT

This disclosure describes a controller operable to control individual cooling components of a plurality of computing devices in a facility. This disclosure also describes obtaining, by a computing system, thermal metrics for a plurality of computing devices in a facility; identifying, by the computing system and based on the thermal metrics, a specific computing device of the computing devices that is at risk of overheating; selecting, by the computing system and based on a model, one or more of a plurality of fans in the facility for which to adjust a parameter to address effects of overheating associated with the specific computing device. The model represents a spatial arrangement of the computing devices and the fans in the facility. Each of the fans is represented as a node in the model. The computing system can send a control signal to adjust the parameter of the selected one or more fans.

This application claims the benefit of India Provisional Patent Application No. 202441086403, filed 9 Nov. 2024, the entire content of which is incorporated herein by reference.

### TECHNICAL FIELD

This disclosure relates to computer networks and, more specifically, to managing temperature in a data center.

### BACKGROUND

Excessive heat can have significant detrimental effects on data centers. Elevated temperatures can lead to hardware failures, resulting in system outages and potential data loss. Additionally, high temperatures can compromise the performance of servers, causing slowdowns that affect the overall energy efficiency of the data center. Prolonged exposure to heat can accelerate the degradation of electronic components, leading to increased maintenance costs and the need for more frequent replacements. In general, inadequate thermal management poses serious risks to the reliability and operational continuity of data centers.

### SUMMARY

This disclosure describes techniques for intelligently detecting potential overheating devices in a network or data center and taking actions to address such overheating devices. This disclosure also describes a controller operable to control individual cooling components of a plurality of computing devices in the network, so as to mitigate address, mitigate, or prevent instances of overheating devices in the data center. In some examples, the controller selects and sends instructions to adjust a parameter of one or more cooling components associated with individual computing devices (e.g., servers) in a data center, such as starting, stopping, modifying a speed of, or otherwise controlling, such one or more cooling components so as to address, mitigate, or prevent instances of overheating devices in the data center. The cooling components can include fans, liquid cooling system elements, or other internal or external cooling components associated with a computing device. For example, the controller may send instructions to control an internal fan that is physically within, i.e., internal to, a server device housing or chassis.

In some examples, the controller generates a graph model representing an approximate spatial arrangement of computing devices, and optionally other data center infrastructure, within a space of a data center. The graph model includes nodes that represent each of a plurality of physical computing devices in a network of the data center, and edges that represent approximate physical distances between the physical computing devices. The graph model may also include nodes that represent virtual computing devices, e.g., virtual execution elements (virtual machines, containers, etc.) that execute on physical computing devices. The graph model may contain data indicative of thermal metrics currently or recently measured at locations associated with the physical computing devices. The graph model may also contain performance metrics collected from the computing devices, which may include usage metrics. The performance metrics may include data indicative of current or predicted CPU utilization, current or predicted memory utilization, and/or numbers of workloads currently being run on the physical or virtual computing devices.

The techniques of the disclosure may provide specific improvements to the computer-related field of computer networking, and more specifically, temperature management of networking and/or computing devices, that may have one or more practical applications. In particular, techniques described herein may help manage power in a computing system to ameliorate energy inefficiencies that occur when operation of computing device cooling components is not centrally managed and is untethered from current performance and cooling requirements of the computing devices of the computer network.

In contrast with, and cause inefficient energy usage where such performance characteristics are not needed to satisfy the requirements of the computing devices served by such network devices, a controller as described herein may reduce the power requirement of a particular computing device, and therefore its energy consumption, by coordinating and distributing the task of cooling the particular computing device among cooling components of multiple computing devices, such as among fans of separate client devices, servers, user equipment (UE) devices etc. For example, using the techniques described herein, a controller may take one or more actions in response to detecting devices that are overheating, or in response to predicted overheating. Such actions may include controlling and modifying server fan speeds across racks of the data center, as described herein. Accordingly, computing devices of a computer network, such as a data center, campus network, or enterprise network, that implements a controller as described herein, may operate in a manner that is significantly more energy-efficient than computing devices that are managed conventionally.

In one example, this disclosure describes a system comprising: storage media; and processing circuitry having access to the memory and configured to: obtain thermal metrics for a plurality of computing devices in a facility; identify, based on the thermal metrics, a specific computing device of the plurality of computing devices that is at risk of overheating; select, based on a model, one or more fans of a plurality of fans in the facility for which to adjust a parameter to address effects of overheating associated with the specific computing device, wherein the model represents a spatial arrangement of the plurality of computing devices and the plurality of fans in the facility, and wherein each of the plurality of fans is represented as a node in the model; and send a control signal to adjust the parameter of the selected one or more fans.

In another example, this disclosure describes a method comprising: obtaining, by a computing system, thermal metrics for a plurality of computing devices in a facility; identifying, by the computing system and based on the thermal metrics, a specific computing device of the plurality of computing devices that is at risk of overheating; selecting, by the computing system and based on a model, one or more of a plurality of fans in the facility for which to adjust a parameter to address effects of overheating associated with the specific computing device, wherein the model represents a spatial arrangement of the plurality of computing devices and the plurality of fans in the facility, and wherein each of the plurality of fans is represented as a node in the model; and sending, by the computing system, a control signal to adjust the parameter of the selected one or more fans.

In another example, this disclosure describes non-transitory, computer-readable storage media comprising instructions that, when executed by processing circuitry, cause a computing system to: obtain thermal metrics for a plurality of computing devices in a facility; identify, based on the thermal metrics, a specific computing device of the plurality of computing devices that is at risk of overheating; select, based on a model, one or more fans of a plurality of fans in the facility for which to adjust a parameter to address effects of overheating associated with the specific computing device, wherein the model represents a spatial arrangement of the plurality of computing devices and the plurality of fans in the facility, and wherein each of the plurality of fans is represented as a node in the model; and send a control signal to adjust the parameter of the selected one or more fans.

In another example, this disclosure describes a system comprising a storage system and processing circuitry having access to the storage system, wherein the processing circuitry is configured to carry out operations described herein. In yet another example, this disclosure describes computer-readable storage media comprising instructions that, when executed, configure processing circuitry of a computing system to carry out operations described herein.

This Summary is intended to provide a brief overview of some of the subject matter described in this document. Accordingly, the above-described features are merely examples and should not be construed to narrow the scope or spirit of the subject matter described herein. Other features, objects, and advantages of the disclosure will be apparent from the description and drawings, and from the claims.

### BRIEF DESCRIPTION OF DRAWINGS

FIG. 1 is a block diagram illustrating an example system including a data center in which examples of the techniques described herein may be implemented.

FIG. 2 is a block diagram illustrating an example arrangement of devices within racks in a data center, in accordance with one or more aspects of the present disclosure.

FIG. 3 is a block diagram illustrating an example computing system in accordance with one or more aspects of the present disclosure.

FIGS. 4A-4B are conceptual diagrams illustrating example airflow paths through racks in a data center that may be determined and managed by a centralized controller, in accordance with one or more aspects of the disclosure.

FIG. 5 is a block diagram illustrating an example computing system in accordance with one or more aspects of the present disclosure.

FIG. 6 is a flowchart illustrating operations performed by an example computing system in accordance with one or more aspects of the disclosure.

FIGS. 7A-7B are block diagrams illustrating an example graph of computing devices and cooling devices in a data center, in accordance with one or more aspects of the present disclosure.

Like reference characters refer to like elements throughout the figures and description.

### DETAILED DESCRIPTION

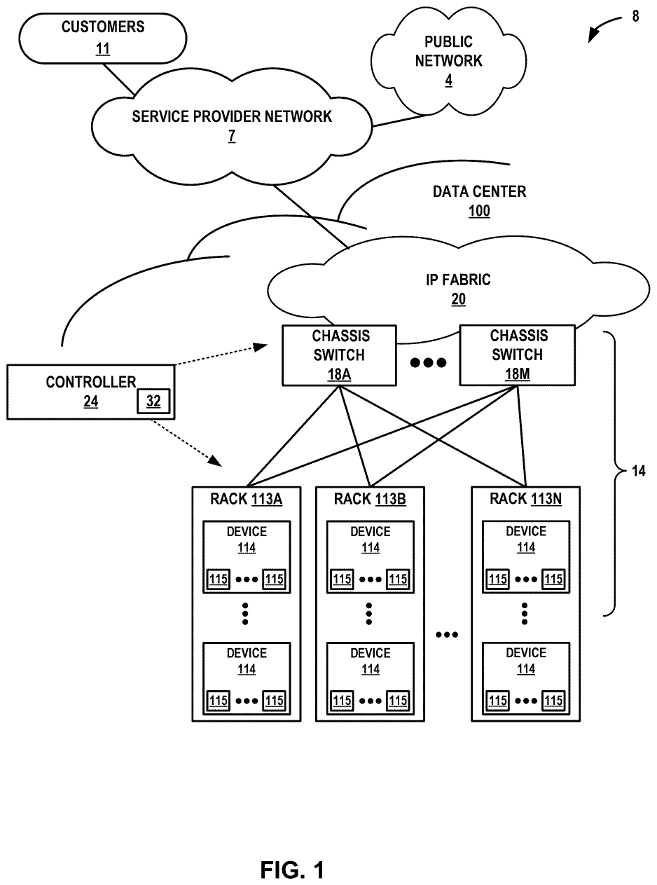

FIG. 1 is a block diagram illustrating an example system 8 including data center 100 in which examples of the techniques described herein may be implemented. In general, data center 100 provides an operating environment for applications and services for one or more customer sites 11 (illustrated as “customers 11”) having one or more customer networks coupled to the data center by service provider network 7. Data center 100 may, for example, host infrastructure equipment, such as networking and storage systems, redundant power supplies, and environmental controls. Service provider network 7 is coupled to public network 4, which may represent one or more networks administered by other providers, and may thus form part of a large-scale public network infrastructure, e.g., the Internet. Public network 4 may represent, for instance, a local area network (LAN), a wide area network (WAN), the Internet, a virtual LAN (VLAN), an enterprise LAN, a layer 3 virtual private network (VPN), an Internet Protocol (IP) intranet operated by the service provider that operates service provider network 7, an enterprise IP network, or some combination thereof.

Although customer sites 11 and public network 4 are illustrated and described primarily as edge networks of service provider network 7, in some examples, one or more of customer sites 11 and public network 4 may be tenant networks within data center 100 or another data center. For example, data center 100 may host multiple tenants (customers) each associated with one or more virtual private networks (VPNs), each of which may implement one of customer sites 11.

Service provider network 7 may offer packet-based connectivity to attached customer sites 11, data center 100, and public network 4. Service provider network 7 may represent a network that is owned and operated by a service provider to interconnect a plurality of networks. In some instances, service provider network 7 represents a plurality of interconnected autonomous systems, such as the Internet, that offers services from one or more service providers.

In some examples, data center 100 may represent one of many geographically distributed network data centers. As illustrated in the example of FIG. 1, data center 100 may be a facility that provides network services for customers. A customer of the service provider may be a collective entity such as enterprises and governments or individuals. For example, a network data center may host web services for several enterprises and end users. Other exemplary services may include data storage, virtual private networks, traffic engineering, file service, data mining, scientific-or super-computing, and so on. Although illustrated as a separate edge network of service provider network 7, elements of data center 100 such as one or more physical network functions (PNFs) or virtualized network functions (VNFs) may be included within the service provider network 7 core.

In the example illustrated in FIG. 1, data center 100 includes devices 114 arranged or housed within racks 113A through 113N (“racks 113”). Each of racks 113 may be coupled to switches 18A through 18M (“chassis switches 18”). Devices 114 may be computing devices such as storage or compute servers, network devices, or other devices. Where devices 114 are servers, such devices may also be referred to herein as “hosts” or “host devices.” Each of devices 114 may include one or more components 115.

Switch fabric 14 in the illustrated example includes one or more racks 113 coupled to a distribution layer of chassis (or “spine” or “core”) routers or switches 18A-18M (collectively, “chassis switches 18”). Each of racks 113 may include a top of rack switch coupled to the chassis switches 18. In some cases, such a top of rack switch may be one of devices 114. Also, data center 100 may include one or more non-edge switches, routers, hubs, gateways, security devices such as firewalls, intrusion detection, and/or intrusion prevention devices, servers, computer terminals, laptops, printers, databases, wireless mobile devices such as cellular phones or personal digital assistants, wireless access points, bridges, cable modems, application accelerators, or other network devices. Techniques described herein may apply to any of these systems or devices.

In the example illustrated in FIG. 1, chassis switches 18 provide devices 114 with redundant (multi-homed) connectivity to IP fabric 20 and service provider network 7. Chassis switches 18 aggregate traffic flows and provides connectivity between racks 113. Switches within network fabric 14 may be network devices that provide layer 2 (MAC) and/or layer 3 (e.g., IP) routing and/or switching functionality. Top of rack switches and/or chassis switches 18 may each include one or more processors and memory, and can execute one or more software processes. Chassis switches 18 are coupled to IP fabric 20, which may perform layer 3 routing to route network traffic between data center 100 and customer sites 11 by service provider network 7. The switching architecture of data center 100 is merely an example. Other switching architectures may have more or fewer switching layers, for instance.

Although devices 114 may represent networking equipment, such as switches or routers, one or more of devices 114 could be a compute node, an application server, a storage server, or other type of server. For example, one or more of devices 114 may represent a computing device, such as an x86 processor-based server, configured to operate according to techniques described herein. In some examples, devices 114 may provide Network Function Virtualization Infrastructure (NFVI) for an NFV architecture.

Devices 114 may host endpoints for one or more virtual networks that operate over the physical network represented here by IP fabric 20 and switch fabric 14. Although described primarily with respect to a data center-based switching network, other physical networks, such as service provider network 7, may underlay the one or more virtual networks.

Controller 24 provides a logically and in some cases physically centralized controller for facilitating operation of one or more virtual networks within data center 100. Controller 24 may manage other aspects of data center 100, which may include managing one or more networks and networking services such as load balancing, and security. For example, controller 24 may be a network management system. Controller 24 may allocate resources from devices 114 that serve as host devices to various applications. Controller 24 may implement high-level requests from an orchestration engine (not specifically shown) configuring physical switches, top-of-rack switches, chassis switches, switch fabric 14; physical routers; physical service nodes such as firewalls and load balancers; and virtual services such as virtual firewalls in a VM. Controller 24 maintains routing, networking, and configuration information within a state database.

Conventionally, a housing or chassis that houses a plurality of computing devices, such as a server rack, may include a server rack fan controller and a plurality of fans. The server rack fan controller may control the fans within the chassis to which the controller belongs, but is unable to centrally control the fans of other server racks. Such aa conventional server rack fan controller does not have any information regarding the heating characteristics (or occurrence of overheating) of nearby or adjacent server racks, and therefore is unable to coordinate its cooling efforts with nearby server racks.

For example, the situation may occur where a first server rack is overheating beyond the capacity of its corresponding fans to provide cooling, while second and third racks that neighbor the first rack are well below temperature limits and using only a tiny fraction the cooling abilities of their corresponding fans. The conventional server rack fan controllers of these three server racks are unable to communicate or coordinate with one another to use the untapped cooling abilities of the neighboring second and third racks to assist in preventing overheating of the first server rack. In addition, conventional attempts to coordinate cooling across multiple server racks may additionally hampered by the use of different makes, models, and form factors of fans and cooling systems between different types of servers and different types of server racks, as well as the use of proprietary connector forms between different types or models of cooling systems.

In accordance with the techniques of the disclosure, controller 24 includes temperature management module 32. Temperature management module 32 performs functions relating to managing heat attributes of devices 114 and/or components 115 across data center 100. In some examples, temperature management module 32 may perform intelligent detection of devices 114 that are overheating. Alternatively, or in addition, temperature management module 32 may evaluate information about heat dissipation properties of devices 114, and/or operate components 115 and predict network disruptions that may occur as a result the heat dissipation properties of such devices 114 or components 115. In some examples, components 115 are fans of devices 114. In some cases, a given device 114 may have more than one associated fan. Conversely, multiple devices 114 may share a fan, such as where the devices are blade servers that are not individually equipped with internal fans or power sources. The techniques of this disclosure can be applied to either configuration.

Temperature management module 32 may also take one or more actions in response to detecting devices that are overheating, or in response to predicted overheating. Such actions may include controlling and modifying server fan speeds across racks of the data center 100, as described herein. Although temperature management module 32 is illustrated in FIG. 1 as being a part of controller 24, in other examples, temperature management module 32 may be implemented separately, or as part of another system, device, or module within system 8.

Controller 24 is operable to send instructions to start, stop, modify a speed of, or otherwise control one or more cooling components associated with individual computing devices (e.g., servers) in a data center, so as to address, mitigate, or prevent instances of overheating devices in the data center. The cooling components can include fans, liquid cooling system elements, or other internal or external cooling components associated with a computing device. For example, the controller may send instructions to control an internal fan that is physically within a server device housing. In contrast to a server rack fan controller that controls fans located on a single rack only, controller 24 can control server fans across multiple racks.

In some examples, controller 24 generates a graph model representing an approximate spatial arrangement of computing devices, and optionally other data center infrastructure, within a space of a data center. The graph model includes nodes that represent each of a plurality of physical computing devices in a network of the data center, and edges that represent approximate physical distances between the physical computing devices. The graph model may also include nodes that represent virtual computing devices, e.g., virtual execution elements (virtual machines, containers, etc.) that execute on physical computing devices. The graph model may contain data indicative of current or predicted CPU utilization, current or predicted memory utilization, and/or numbers of workloads currently being run on the physical or virtual computing devices. The graph model may contain data indicative of thermal metrics currently or recently measured at locations associated with the physical computing devices.

As an example of the techniques of the disclosure, temperature management module 32 obtains thermal metrics for devices 114 in data center facility 100. Temperature management module 32 identifies, based on the thermal metrics, a specific device 114 of devices 114 that is at risk of overheating. Temperature management module 32 selects, based on a model, one or more of fans 115 in data center facility 100 for which to adjust a parameter to address effects of overheating associated with the specific device 114. In some examples, the model represents a spatial arrangement of devices 114 and fans 115 in data center facility 100. In some examples, each of devices 114 and fans 115 is represented as a node in the model. In some examples, the model is a graph model. Temperature management module 32 sends a control signal to adjust the parameter of the selected one or more fans 115. In some examples, the parameter is a fan speed, an on state, an off state, or a mode of operation of the selected one or more fans 115.

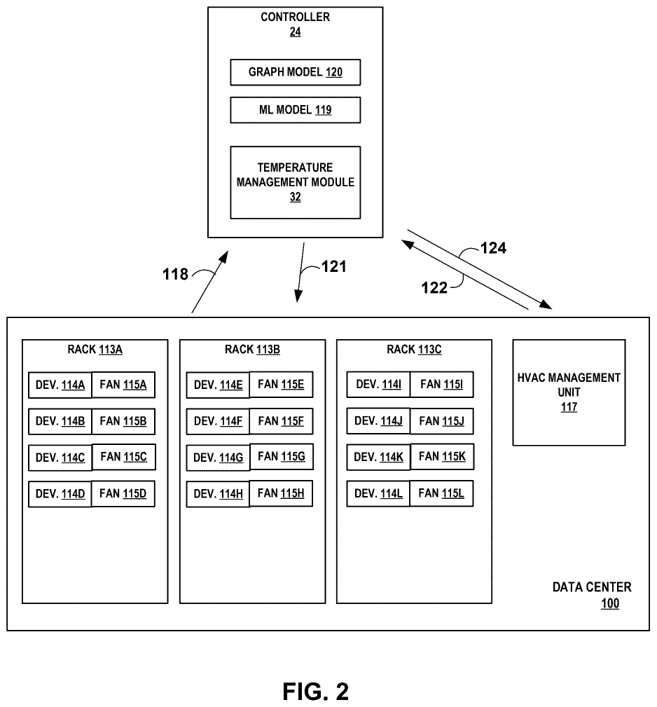

FIG. 2 is a block diagram illustrating an example arrangement of devices within racks in a data center, in accordance with one or more aspects of the present disclosure. FIG. 2 includes some of the same elements of system 8 of FIG. 1, including data center 100, which may correspond to data center 100 of FIG. 1. FIG. 2 also illustrates racks 113A and 113B, which may be an example selection of the racks 113A through 113N illustrated in FIG. 1. FIG. 2 further illustrates controller 24, which could be controller 24 of FIG. 1, and which includes temperature management module 32.

As in FIG. 1, each of racks 113 in FIG. 2 includes a number of network devices or devices 114. Specifically, rack 113A includes devices 114A, 114B, 114C, and 114D and fans 115A, 115B, 115C, and 115D. Rack 113B includes devices 114E, 114F, 114G, and 114H and fans 115E, 115F, 115G, and 115H. Further, rack 113C includes devices 114I, 114J, 114K, and 114L and fans 115I, 115J, 115K, and 115L. For convenience, devices 114A-114L are collectively referred to as “devices 114” and fans 115A-115L are collectively referred to as “fans 115.” For ease of illustration, only a limited number of racks 113 and devices 114 are illustrated in FIG. 2, but techniques described herein may apply in situations involving any number of racks or devices.

In general, devices 114 may consist of servers distributed by different vendors having different thermal characteristics. In data center networks, the network devices will be arranged in racks one above the other, as depicted in FIG. 2. When setting up a network, an administrator typically arranges devices 114 based on cabling and connectivity requirements. However, this arrangement can sometimes result in uneven airflow distribution, causing some devices to receive insufficient cooling. This can lead to overheating and, eventually, device failure or shutdown.

Temperature management module 32 of controller 24 receives data 118 from devices 114 of racks 113, including temperature sensor data, and based on detecting a device 114 that is overheating or likely to overheat, sends control signals 121 to devices 114 to start, stop, and/or control a speed of one or more corresponding fans within particular ones of devices 114 to modify the flow of air through racks 113 and data center 100. Temperature management module 32 may also receive data 122 from HVAC management unit 117, and send control signals 124 to HVAC management unit 117 to control operation of one or more components of an HVAC system of data center 100 managed by HVAC management unit 117.

In some examples, but not necessarily all, the functionality of temperature management module 32 is integrated into the network controller 24 that manages data center 100 or the data center's devices. Temperature management module 32 may periodically gather temperature data from various sensors within each device 114, primarily from temperature sensors placed at key locations on the device chassis of each device. These data provide insight into the thermal behavior of the devices. In some examples, an interface such as Juniper Junos Telemetry Interface (JTI) is the underlying mechanism that collects and streams device data from network devices, such as switches and routers, to external data collectors. JTI supports standard data models like OpenConfig and proprietary Juniper models and can stream data over gRPC or UDP.

Temperature management module 32 may store the collected data 118, 122 in a time-series database, allowing for periodic analysis of temperature metrics. Using this data, temperature management module 32 may calculate analytical metrics such as the rate of heating and rate of cooling. The rate of heating measures the increase in a device's temperature per unit of time, while the rate of cooling tracks a temperature decrease over the same period.

Without automated preventive monitoring systems, network disruptions can persist until administrators manually investigate and identify the root cause, whether it is ventilation problems, faulty components, or problematic upgrades. Predictive cooling management is particularly beneficial in large-scale data centers, where thermal issues can otherwise result in significant network disruptions.

Temperature management module 32 of controller 24 (see FIG. 1) may use heat dissipation patterns to proactively identify network devices 114 at risk of overheating, enabling thermal issues to be addressed before they cause problems, disruptions, or failures.

Heat dissipation is an indicator of the amount of heat generated by device components 115 getting dissipated when air flowed over the chassis components. In FIG. 2, temperature management module 32 may continuously monitor heat dissipation across different chassis components using strategically placed temperature sensors (e.g., inset sensors and outlet sensors). This measurement indicates how effectively generated heat is being removed by airflow across the components. By tracking these heat dissipation patterns over time, temperature management module 32 can assess the cooling efficiency of each component.

In some examples, temperature management module 32 stores component heat dissipation metrics in a time-series database. For example, heat management module may determine a heat dissipation metric for a component in a rack 114 by computing the difference of the temperature between an inlet temperature and an outlet temperature of a component.

Temperature management module 32 may use this historical data to train machine learning models. These trained models forecast future heat dissipation patterns for each chassis component. By analyzing these predictions, temperature management module 32 (or the network controller 24) can identify components at risk of overheating and potential failure. This proactive approach allows temperature management module 32 or network administrators to address thermal issues before they cause network disruptions.

Accordingly, in some examples, temperature management module 32 may generate predictions about potential server device overheating based on received temperature data, such as by using a ML model trained on historical temperature data. In response to such sensor data determinations, heat management module may use the determinations to generate control signals that are used to control other systems within the data center 100 (or the system 8 generally, see FIG. 1). Specifically, temperature management module 32 may send control signals to one or more computing devices (e.g., servers) within data center 100, instructing one or more of such devices to modify the speed of one or more fans within a housing of the device. Accordingly, temperature management module 32 may control the operation of various other systems through predictions made by applying a machine learning module trained to identify heating issues.

In some examples, temperature management module 32 may apply the ML model to identify one or more trends in the historical data so as to predict instances of overheating of devices 114. For example, trends in the historical data may reveal that where data center 100 is an enterprise or business-related data center, during certain times, such as after business hours, during weekends, or on holidays local to a geographic region within which data center 100 is located, devices 114 may experience lesser amounts of workloads (and correspond lower temperatures) than during regular business hours. In contrast, where data center 100 is related to the provision of personal or entertainment services, devices 114 may experience higher amounts of workloads (and correspond higher temperatures) during such times. Based on the identification of such trends, temperature management module 32 may configure fans 115 to have, e.g., higher fan speeds in advance of the occurrence of a predicted increase in workloads so as to proactively prevent or mitigate instances of overheating of devices 114. As another example, temperature management module 32 may configure fans 115 to have, e.g., lower fan speeds in advance of the occurrence of a predicted decrease in workloads so as to proactively increase the energy efficiency of data center 100 where high fan speeds are not required to effectively cool devices 114.

In addition, by predicting future cooling needs of devices 114, temperature management module 32 may preemptively increase a fan speed of fans 115. By increasing cooling before temperature rises to a problematic temperature, temperature management module 32 may enable more energy efficiency over conventional systems, because it may be more energy efficient to maintain a particular temperature, than to allow data center 100 to heat up to a high temperature and cool the facility back down to a particular temperature.

In some examples, data 118 may include geographical location data of devices 114. Temperature management module 32 may apply the ML model to identify one or more trends in the geographical location data so as to predict instances of overheating of devices 114. For example, geographical location of devices 114 may reveal times at which devices 114 are more prone to overheating based on a season of the year (e.g., summer vs. winter, day vs. night). As another example, geographical location of devices 114 may reveal which devices 114 are more prone to overheating due to a physical location within data center 100 of devices 114, such as a location where devices 114 may receive less airflow, and therefore fans 115 may be less effective at cooling devices 114 (e.g., such as devices centrally located within data center 100, or devices located far from a cool air intake or hot air exhaust vent, thereby placing the device away from a flow path of air).

Temperature management module 32 may apply the ML model to additional types of data received from devices 114, HVAC management unit 117, and/or data center 110 to identify other types of trends in the historical data that may assist temperature management module 32 in selecting fans 115 and adjusting parameters of such selected fans to as to prevent or mitigate overheating of devices 115.

Additional examples relating to techniques for identifying and remediating overheating devices are described in application Ser. No. 19/343,375, entitled “IDENTIFYING AND REMEDIATING OVERHEATING DEVICES,” filed Sep. 29, 2025, the entire contents of which are incorporated by reference.

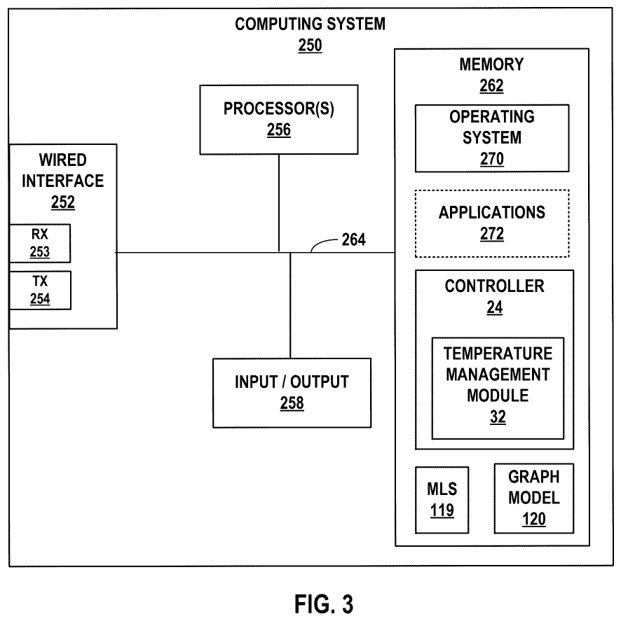

FIG. 3 is a block diagram illustrating an example computing system 250, in accordance with the techniques described in this disclosure. Computing system 250 of FIG. 2 may be configured to execute controller 24 or temperature management module 32 of FIG. 1.

In this example, computing system 250 includes a communications interface 252, e.g., an Ethernet interface, a processor 256, input/output 258, e.g., display, buttons, keyboard, keypad, touch screen, mouse, etc., a memory 262 coupled together via a bus 264 over which the various elements may interchange data and information. Communications interface 252 couples the computing system 250 to a network, such as an enterprise network. Though only one interface is shown by way of example, those skilled in the art should recognize that network nodes may, and usually do, have multiple communication interfaces. Communications interface 252 includes a receiver (RX) 253 via which the computing system 250, e.g., a server, can receive data and information. Communications interface 252 includes a transmitter (TX) 254, via which the computing system 250 can send data and information.

Processor(s) 256 execute software instructions, such as those used to define a software or computer program, stored to a computer-readable storage medium (such as memory 262), such as non-transitory computer-readable media including a storage device (e.g., a disk drive, or an optical drive) or a memory (such as Flash memory or RAM) or any other type of volatile or non-volatile memory, that stores instructions to cause the one or more processors 256 to perform the techniques described herein. Examples of processor(s) 256 may include, any one or more of a microprocessor, a controller, a digital signal processor (DSP), an application specific integrated circuit (ASIC), a field-programmable gate array (FPGA), or equivalent discrete or integrated logic circuitry.

Memory 262 includes one or more devices configured to store programming modules and/or data associated with operation of computing system 250. For example, memory 262 may include a computer-readable storage medium, such as non-transitory computer-readable media including a storage device (e.g., a disk drive, or an optical drive) or a memory (such as Flash memory or RAM) or any other type of volatile or non-volatile memory, that stores instructions to cause the one or more processor(s) 256 to perform the techniques described herein. Memory 262 stores executable operating system 270 and may, in various configurations, store instructions for software applications 272, controller 24, and/or temperature management module 32.

Input/Output 258 may include one or more input devices and one or more output devices of computing system 250. The input device(s) of Input/Output 258 may generate, receive, and/or process input. For example, the input device(s) of Input/Output 258 may generate or receive input from a network, a user input device, or any other type of device for detecting input from a human or machine. The output device(s) of Input/Output 258, in some examples, are configured to provide output to a user using tactile, audio, or video stimuli. The output device(s) of Input/Output 258, in one example, includes a presence-sensitive display, a sound card, a video graphics adapter card, or any other type of device for converting a signal into an appropriate form understandable to humans or machines. Additional examples of output device(s) of Input/Output 258 include a speaker, a cathode ray tube (CRT) monitor, a liquid crystal display (LCD), or any other type of device that can generate intelligible output to a user.

Computing system 250 further includes temperature management module 32. Temperature management module 32 includes energy efficiency module 32 and machine learning system 33, which operate in a similar fashion as described above with respect to FIG. 1. Computing system 250 implements controller 24 and temperature management module 32 as software or a combination of software and hardware.

In accordance with the techniques of the disclosure, controller 24 includes temperature management module 32. In the example of FIG. 3, temperature management module 32 is implemented within controller 24, which is a centralized controller for devices 114 and fans 115 of data center 100. In other examples, temperature management module 32 may be implemented as an application within one of devices 114, while still providing centralized temperature management for devices 114 and fans 115 of data center 100. In some examples, devices 114 are network devices, such as servers, compute nodes of a cloud computing network, routers, switches, gateways, firewalls, etc. In some examples, data center 100 includes a plurality of racks (e.g., also referred to as “housings” or “chassis”) 113. Each rack includes, for example, two more devices 114 and two or more fans 115.

Temperature management module 32 obtains thermal metrics for devices 114 in data center facility 100. In some examples, each rack 113 includes a plurality of sensors placed at a plurality of locations within each rack 113. Temperature management module 32 obtains the thermal metrics of each of the sensors of each chassis. In some examples, the thermal metrics comprise temperature data, such as a temperature sensed by the sensor, a rate of change in temperature sensed by the sensor, etc.

Temperature management module 32 identifies, based on the thermal metrics, a specific device 114 of devices 114 that is at risk of overheating. In some examples, temperature management module 32 identifies the specific device 114 based on a temperature of the device 114, a rate of change of temperature of the specific device 114, a current load or a forecasted demand of the specific device 114, or a resource utilization, such as a Centralized Processing Unit (CPU), Graphics Processing Unit (GPU), memory, or network utilization of the specific device 114.

Temperature management module 32 selects, based on a model, one or more of fans 115 in data center facility 100 for which to adjust a parameter to address effects of overheating associated with the specific device 114. In some examples, the model represents a spatial arrangement of devices 114 and fans 115 in data center facility 100. In some examples, each of devices 114 and fans 115 is represented as a node in the model. In some examples, the model is a graph model.

In some examples, temperature management module 32 constructs the graph model based on information received from computing devices 114. In some examples, the graph model defines one or more constraints to be applied to computing devices 114, such as a maximum temperature, a target temperature, geographic location of computing devices 114 within data center 100, one or more fans 115 associated with each corresponding device 115, etc.

In some examples, to select the one or more fans 114, temperature management module 32 applies a Shortest Path First (SPF) algorithm to construct a flow path of air flowing through computing devices 114. The flow path comprises at least two fans 115. Temperature management module 32 selects the at least two fans 115 for which to adjust the parameter.

In some examples, the flow path further comprises a cool air intake system, the specific computing device 114 identified as at risk of overheating, and one or more hot air exhaust vents. Temperature management module 32 constructs the flow path so as to transport air from the cool air intake system, across the specific computing device 114 identified as at risk of overheating, and toward the one or more exhaust vents. In addition, to adjust the parameter of the selected one or more fans 115, temperature management module 32 increases a fan speed of the selected one or more fans 115 so as to implement the flow path.

In some examples, a specific device 114 at risk of overheating is positioned within a first chassis, e.g., rack 113A of FIG. 1. In some examples, to select the one or more fans, temperature management module 32 selects one or more fans 115 within rack 113A to adjust the parameter to mitigate or remediate the risk of overheating of the specific device 114. In some examples, to select the one or more fans, temperature management module 32 selects one or more fans 115 within a nearby rack, such as rack 113B, to adjust the parameter to mitigate or remediate the risk of overheating of the specific device 114.

Temperature management module 32 sends a control signal to adjust the parameter of the selected one or more fans 115. In some examples, the parameter is a fan speed, an on state, an off state, or a mode of operation of the selected one or more fans 115.

In some examples, each computing device 114 is associated with one or more fans 115. For example, a first device 114 may be associated with two fans 115 that are, e.g., positioned within a same chassis or located proximate to the first device 114 such that the fans may provide cooling to the first device 114. In this example, to select the one or more fans, temperature management module 32 selects one or more fans 115 based on at least one of a current load or a forecasted demand of each of computing devices 114 with which the one or more fans 115 are associated. In some examples, the current load or forecasted demand includes, e.g., one or more of CPU utilization, GPU utilization, memory utilization, or bandwidth utilization. In further example, temperature management module 32 selects one or more fans 115 based on a real-time resource usage of each of computing devices 114 with which the one or more fans 115 are associated.

In some examples, temperature management module 32 selects one or more fans 115 associated with one or more devices 114 based on at least one of a predicted future load of each specific device 115. In this example, temperature management module 32 determines the predicted future load based on a pattern of one or more of peak times, incoming tasks, or scheduled events of the specific device 114.

In some examples, temperature management module 32 selects one or more fans 115 associated with one or more devices 114 based on a potential future temperature increase of each specific device 115. In this example, temperature management module 32 determines the potential future temperature increase based on a workload pattern associated with the specific device 114.

For example, based on a determination that a first computing device 114 has a current or forecasted load that is low (e.g., such that cooling by associated fans may be underutilized) but a second, proximate computing device 114 has a current or forecasted load that is high (e.g., such that cooling by associated fans may be overutilized), temperature management module 32 selects one or more fans 115 associated with the first computing device 114. In addition, temperature management module 32 may increase a speed of the one or more fans 115 associated with the first computing device 114, even though such an increase is not needed to provide cooling to the first computing device 114, so as to provide supplemental cooling of second computing device 114 (for which its associated fans may be unable to provide adequate cooling).

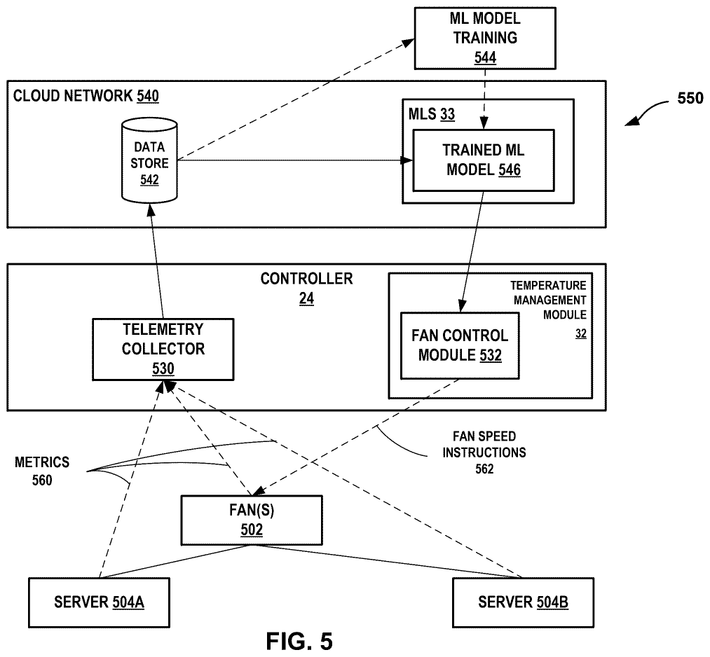

In some examples, temperature management module 32 implements a machine learning model (described in more detail with respect to FIG. 5). Temperature management module 32 train the machine learning model using at least some of the thermal metrics obtained from devices 114. Temperature management module 32 applies the machine learning model to input data, such as the thermal metrics obtained for devices 114, to make a prediction of one or more devices 114 that are at risk of overheating. Temperature management module 32 selects the one or more fans 115 based on the prediction from the machine learning model of one or more devices 114 that are at risk of overheating.

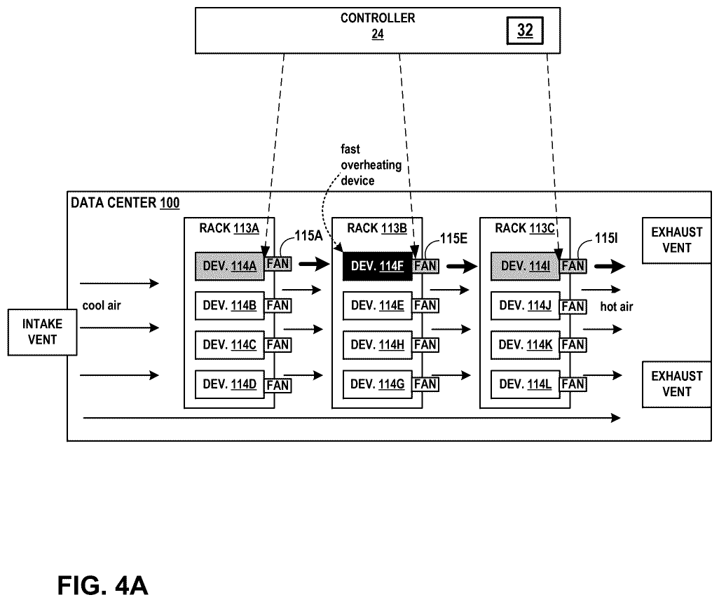

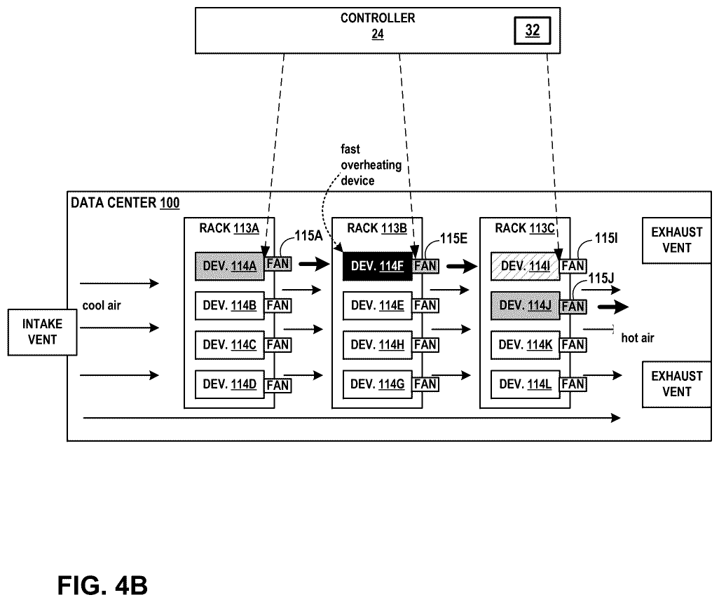

FIGS. 4A-4B are conceptual diagrams illustrating example airflow paths through racks in a data center that may be determined and managed by a centralized controller, in accordance with one or more aspects of the disclosure.

### Collaborative Cooling in Data Centers

In air-cooled data centers, cold air is usually distributed through vents, while relatively hot air generated by equipment like servers is expelled through separate vents. If a single server overheats, it may take some time to cool down because its fans alone may not be powerful enough to draw in sufficient cold air.

To address this, a controller can activate fans in neighboring servers, allowing multiple servers to work together to pull cold air more effectively and cool the overheating server. This is in contrast to a cooling model where each server manages its own fans, and HVAC is managed by a different controller. In a large data center with thousands of servers, there are thousands of device managers working independent of each other, which is very inefficient.

When selecting which servers to involve in this process, it can be important to consider both their current temperature and predicted future temperatures to avoid overloading them. Controller 24 may select servers to participate in this cooling process from the same rack or adjacent racks due to proximity, which improves energy and cooling efficiency. However, careful consideration must be given to the servers'current load and forecasted demand. Selecting servers purely based on physical proximity could lead to imbalances in resource utilization, with some servers becoming overutilized while others remain underused.

### Adaptive Fan Speed Controller

Fans are essential components in any server system, playing a crucial role in maintaining optimal operating temperatures, especially during periods of high CPU activity. These fans ensure that heat generated by the server components is efficiently dissipated, preventing overheating and maintaining system stability.

If a fan fails or if the internal airflow becomes obstructed due to dust buildup, improper cable management, or other issues, the cooling efficiency is significantly reduced. This leads to a sudden rise in the internal temperature of the server. High temperatures can severely impact server performance, leading to thermal throttling, hardware degradation, or even catastrophic system failure if not addressed promptly.

To avoid such risks, administrators often choose to shut down the affected servers for repairs or maintenance when fan failures or airflow blockages occur, which can be costly. Powering down servers results in downtime, which disrupts services, impacts productivity, and may lead to financial losses, particularly in environments where uptime is critical, such as data centers, cloud services, or enterprise systems.

In servers, fans are typically controlled by the OS using onboard sensors that adjust fan speeds based on local temperatures. In large data centers, this results in thousands of independent fan controllers operating separately. Introducing a centralized controller to manage all fans from one location offers significant benefits for thermal optimization.

With centralized control, cooling can be coordinated across the entire data center, improving airflow efficiency and reducing energy consumption. Predictive analytics could anticipate temperature rises, allowing fans to adjust preemptively. Energy efficiency is enhanced as fan speeds are optimized for varying workloads, and cooling can be better synchronized with other systems like air conditioning. Centralized control also simplifies management, offering a single interface for monitoring and maintenance, while providing better failover options in the event of fan failures.

In short, centralized fan control improves cooling efficiency, reduces energy usage, and simplifies maintenance, leading to cost savings and better overall data center performance.

Controller 24 can optimize airflow by adjusting fan speeds in chassis near cool air intakes and along airflow paths. By increasing the speed of intake fans and fans in hotter areas, it ensures efficient cooling throughout the data center. The controller directs hotter air toward cooler zones, preventing overheating and reducing hot spots.

This approach balances airflow, improves cooling efficiency, and reduces energy consumption by targeting specific areas rather than uniformly increasing fan speeds. It adapts to real-time temperature changes, ensuring optimal airflow and preventing hardware failure due to localized heat buildup.

In addition, controller 24 with predictive analytics enhances cooling by anticipating temperature spikes based on workload patterns, enabling preemptive fan adjustments. This can lead to: Preemptive Cooling: Fans speed up before temperatures rise, preventing overheating. Energy Savings: Fans operate more efficiently, reducing unnecessary energy usage. Reduced Wear and Tear: Smarter adjustments extend fan lifespan by avoiding constant reactive changes.

As depicted in the examples of FIGS. 4A-4B, centralized controller 24 manages and optimizes airflow dynamically. Controller 24 would take advantage of the fans that are already present in multiple servers, strategically coordinating their operation to guide the movement of hot air more effectively. By utilizing a SPF (Shortest Path First) algorithm, the controller can create an “invisible” flow path for hot air to flow directly to exhaust vents, bypassing unnecessary detours and minimizing recirculation. In some examples, the SPF algorithm can likewise be used to create a flow path for cool air to flow directly from cool air intake vents toward potentially overheating computing device(s), to efficiently cool those computing devices.

In some examples, the shortest path first algorithm is Dijkstra's algorithm for finding the shortest paths between nodes in a weighted graph. Such an algorithm uses a min-priority queue data structure for selecting the shortest paths so far known. The weighted graph may be a directed acyclic graph, in some examples. In some examples, the algorithm may be the Bidirectional Dijkstra algorithm.

In one example, the controller applies the SPF algorithm to calculate a route for the hotter air in the space to flow to the exhaust vent(s), e.g., based on collected values of real-time temperature and airflow conditions within the room. The route may be selected as the “shortest” in the sense of the most energy-efficient and/or fastest way to move the relatively hot air away from a computing device that is at risk of overheating. This dynamic approach enables relatively hot air to evacuate quickly, reducing the time it takes to cool the room and improving overall energy efficiency. The controlled movement of air would help maintain a more consistent temperature and prevent hot spots, leading to improved performance and longevity of the equipment.

Once controller uses the SPF to identify the servers that are on the flow path to reach the exhaust vent in the shortest way, the controller sends a control signal to the server to turn on one or more fans in each server on the flow path so that hot air gets out quickly.

Instead of selecting just one server to run its fan(s) at full speed, the controller may select multiple servers in the same rack and work together to send the hot air out, potentially using a lower fan speed to balance the work of running the fan across the multiple servers, which leaves some server resources available for running workloads and increasing fan speed further due to its own workloads causing a need for additional cooling.

In the case of multiple exhaust vents being available, the SPF may identify multiple flow paths to “load balance” the hot air towards the multiple exhaust vents, or may select a single exhaust vent from among a plurality of candidate exhaust vents.

In another example, the controller applies the SPF algorithm to calculate a route for cool air in the space to travel from a cool air intake system to a computing device likely to overheat, and uses the route information to select each of a plurality of fans on the route to increase their fan speed relative to other fans that may be turned off or have lower speeds.

Controller 24 creates a graph model that represents the relative positions of computing devices in the facility based on spatial information learned from the network devices and/or received from an administrator. Controller 24 processes the spatial information to build a working model of a physical arrangement of the computing devices in space relative to each other. In some examples, the received spatial information is simply a server name. In some examples, the spatial information includes a corresponding index number assigned to each rack, and/or each server within the rack. If the server naming convention includes an incremental numbering scheme, the assigned server names can be used by controller 24 to guess which servers are next to other racks, by virtue of being assigned names with related or neighboring integer values. In some examples, servers may be named following a convention of “building name,” followed by “floor name,” followed by “rack name,” followed by an index number within the rack. For example, a server name of “B.6.30.2” would indicate the server is on the sixth floor of Building B, and it is the second server in rack number 30.

In some examples, the received spatial information may include spatial information entered by an administrator, such as by importing a spreadsheet, or using a graphical user interface tool to arrange server and rack icons on the UI in the correct relative spatial arrangement, which is then translated into spatial information consumable by controller 24.

The spatial information may also include information about any facility infrastructure (e.g., walls, HVAC equipment, vents), that may affect the flow of air in the facility. Controller 24 may also account for one or more fluid dynamic principles, inputs, or constraints that are applied to the graph model. Controller 24 may also update the stored graph model 120 and ML model 119 based on feedback from temperature sensor data received after controller 24 sends instructions to modify one or more fan speeds. For example, noticeable temperature discontinuities at what controller 24 had initially guessed were neighboring devices can inform controller 24 of incorrect assumptions in its initial graph and enable an updated graph to be generated. As another example, if the initial modification instructions do not result in a suitably lowered computing device temperature where controller 24 intended, or a suitable improvement in performance metrics of a target computing device 114, controller 24 may consider updating its graph model in view of this unexpected result, to a spatial arrangement that would make more sense given the measured results.

Controller 24 can obtain data indicative of current fan speeds of each fan of a plurality of fans, from a software agent or management module executing on each of the plurality of computing devices. Controller 24 may determine and command the computing devices 114 to run the fans at different speeds depending on the distance between the racks, such as by using a faster fan speed for a larger distance between the racks. That behavior can be learned, in a close-loop system.

A software agent, running on an operating system of the server, can receive a command from controller 24 that causes the operating system to send one or more signals to operate one or more fans of the server, such as by controlling operation of the fan's motor. For example, the commands can cause the operating system to turn the fan (or more specifically, the fan's motor element) to an on state from an off state or vice versa; or change the speed of the fan from a current speed to a requested speed. For example, controller 24 may send instructions to cause the fan to rotate at a faster rate or a slower rate, where the rates may be predefined settings or may be a specific number of revolutions per minute (rpm) directly specified by the controller commands. In some examples, controller 24 may cause a fan to enter a particular mode of operation, such as to operate at a speed within a defined range, a fuzzy mode, or other defined mode. Controller 24 can send commands and/or receive telemetry data from the computing devices 114 using any network management communication process or protocol, such as streaming telemetry (e.g., OpenTelemetry), NETCONF, Simple Network Management Protocol (SNMP), Internet Control Messaging Protocol (ICMP), Syslog, RESTCONF, OpenFlow, discovery protocols (e.g., CDP), and eXtensible Messing and Presence Protocol (XMPP), for example.

Controller 24 selection of participating servers (or their associated fans) will, in some examples, be based on information obtained by controller 24 about the servers' current load and/or anticipated future demands. This ensures a better distribution of the cooling task, minimizing potential bottlenecks and improving overall performance.

As depicted in the example of FIG. 4A, temperature management module 32 of controller 24 has determined, based on received telemetry data including thermal metrics, that computing device 114F is a fast overheating device (either currently or predicted). Based on this determination, temperature management module 32 applies a shortest path first algorithm to a graph model depicting the arrangement of fans 115 and computing devices 114 in data center 100, to identify a shortest path between computing device 114F and one or more of the nearest exhaust vents. In some examples, the shortest path may be calculated between a cold air intake vent and a hot air exhaust vent, and which traverses device 114F. Based on the calculated shortest path, temperature management module 32 identifies a flow path for hot air to quickly flow away from computing device 114F. In the example of FIG. 4A, this flow path includes fan 115A, fan 115E, and fan 115I.

As depicted in the example of FIG. 4B, assume controller 24 determines based on new telemetry data or predictive analytics that computing device 114I has its own increased resource demands, such as additional workloads. In response to determining this, temperature management module 32 of controller 24 may update the graph model 123 to modify a weighting associated with computing device 114I or its associated fan 115I, and in turn updates its selection of a flow path based on the updated graph model. As a result, the selected flow path may no longer rely on fan 115J for assistance in cooling computing device 114F, and controller 24 may instead modify parameters of a fan 115J associated with computing device 114J instead of fan 115I, to enable faster cooling of computing device 114F.

As one example, temperature management module 32 may select a flow path based on current load associated with the plurality of servers. In this scenario, fans 115 associated with servers are chosen based on the server's real-time resource usage. Servers with lower CPU, memory, and bandwidth utilization are prioritized for increasing their fan's speed, ensuring that no single server is overloaded with trying to cool itself while others remain underutilized.

As another example, temperature management module 32 may select a flow path based on a forecasted load associated with servers. Here, server fans are selected for parameter adjustment not only based on each of the plurality of servers'current usage, but also by predicting future load based on patterns such as peak times, incoming tasks, or scheduled events. Using machine learning model 119 and/or historical data analysis, controller 34 can predict spikes in demand and allocate cooling resources accordingly, preventing overheating before it occurs. And in some examples, temperature management module 32 may select a flow path based on information about both the current loads and the forecasted loads.

FIG. 5 is a block diagram is a block diagram illustrating an example computing system 550 in accordance with one or more aspects of the present disclosure. As shown in FIG. 5, temperature management module 32 configures a parameter of fan 502, based on a temperature of servers 504A-504B (collectively, “servers 504”), in accordance with the techniques of the disclosure. In some examples, computer network 550 is an example implementation of system 8 of FIG. 1.

In the example of FIG. 5, and in accordance with the techniques of the disclosure, temperature management module 32 controls individual cooling components of a plurality of servers 504, so as to mitigate address, mitigate, or prevent instances of overheating devices. In some examples, temperature management module 32 selects, and sends instructions to adjust a parameter of one or more cooling components, such as fan 502, associated with servers 504, such as starting, stopping, modifying a speed of, or otherwise controlling, such one or more cooling components so as to address, mitigate, or prevent instances of overheating devices in the data center. For example, the controller may send instructions to control an internal fan that is physically within, i.e., internal to, a housing or chassis of one or more servers 504.

In some examples, temperature management module 32 generates a graph model representing an approximate spatial arrangement of servers 504, and optionally other data center infrastructure, such as fan(s) 502, within a space of a data center. The graph model includes nodes that represent each of servers 504, and edges that represent approximate physical distances between servers 504. The graph model may also include nodes that represent virtual computing devices, e.g., virtual execution elements (virtual machines, containers, etc.) that execute on physical computing devices (e.g., servers 504). The graph model may contain data indicative of thermal metrics currently or recently measured at locations associated with servers 504. The graph model may also contain performance metrics collected from servers 504, which may include usage metrics. The performance metrics may include data indicative of current or predicted CPU utilization, current or predicted memory utilization, and/or numbers of workloads currently being run on the physical or virtual computing devices.

In the example of FIG. 5, telemetry collector 530 of controller 24 collects thermal metrics 560 to monitor a temperature of each of servers 504. In some examples, thermal metrics 560 may additionally or alternatively include performance metrics indicative of, e.g., server workload, CPU, memory, or network utilization, etc.

Controller 24 provides monitored metrics 560 of servers 504 to a data store of 542 of cloud network 540. In some examples, ML model training module 544 performs ML model training based on this data from servers 504 to train trained ML model 546 to predict one or more servers 504 at risk of overheating at a given time window. In other examples, trained ML model 546 is initially (or only) trained based on other third-party data, independent of network 550, and not based on data from servers 504. In some examples, such a trained ML model 546 may be updated over time based on monitored metrics 560. In some examples, trained ML model 546 may be part of controller 24.

Temperature management module 32 applies trained ML model 546 to metrics 560 obtained from servers 504 to predict server 504A is at risk of overheating. Based on the prediction that server 504A is at risk of overheating, temperature management module 32 selects one or more fans 502 to which to adjust a parameter to address effects of overheating associated with server 504A. Fan control module 532 sends a control signal to adjust the parameter of the selected fan(s) 502. In some examples, the parameter is a fan speed, and fan control module 532 sends fan speed instructions 562 to fan(s) 502. Therefore, controller 24, using the techniques of the disclosure, may determine or predict one or more servers 504 at risk of overheating, and adjust a parameter of fan(s) 502 to mitigate or prevent overheating of the one or more servers 504.

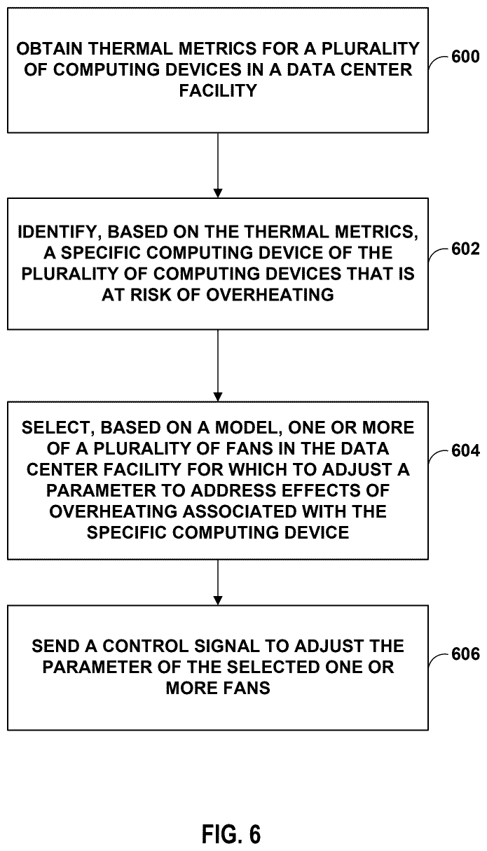

FIG. 6 is a flowchart illustrating operations performed by an example computing system in accordance with one or more aspects of the disclosure. For convenience, the operation of FIG. 6 is described with respect to FIG. 1, but FIG. 6 may describe operation of any instance of controller 24 and/or temperature management module 32 described in any of FIGS. 1-5.

In accordance with the techniques of the disclosure, temperature management module 32 obtains thermal metrics for devices 114 in data center facility 100 (600). Temperature management module 32 identifies, based on the thermal metrics, a specific device 114 of devices 114 that is at risk of overheating (602). Temperature management module 32 selects, based on a model, one or more of fans 115 in data center facility 100 for which to adjust a parameter to address effects of overheating associated with the specific device 114 (604). In some examples, the model represents a spatial arrangement of devices 114 and fans 115 in data center facility 100. In some examples, each of devices 114 and fans 115 is represented as a node in the model. In some examples, the model is a graph model. Temperature management module 32 sends a control signal to adjust the parameter of the selected one or more fans 115. In some examples, the parameter is a fan speed, an on state, an off state, or a mode of operation of the selected one or more fans 115.

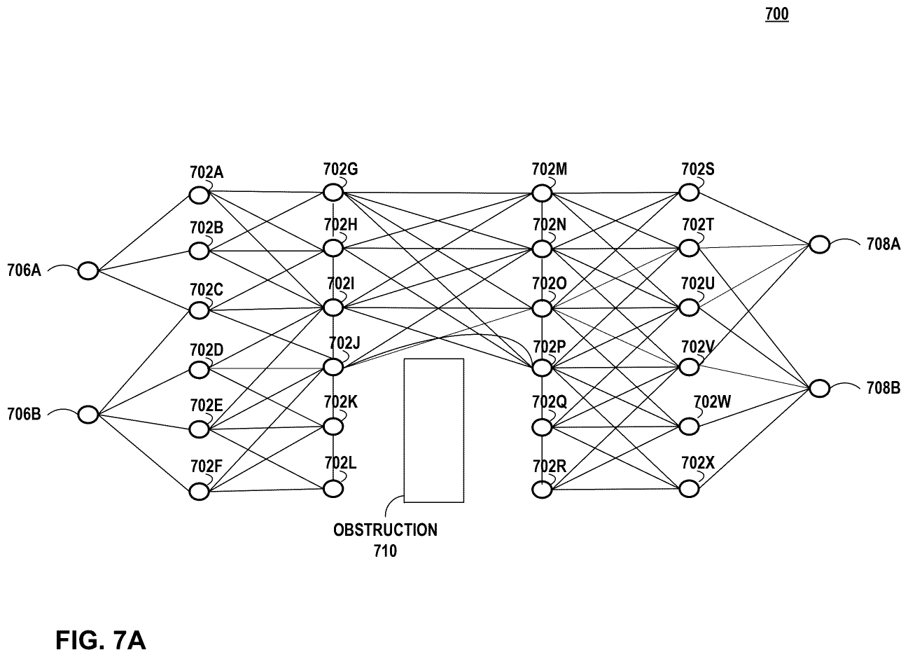

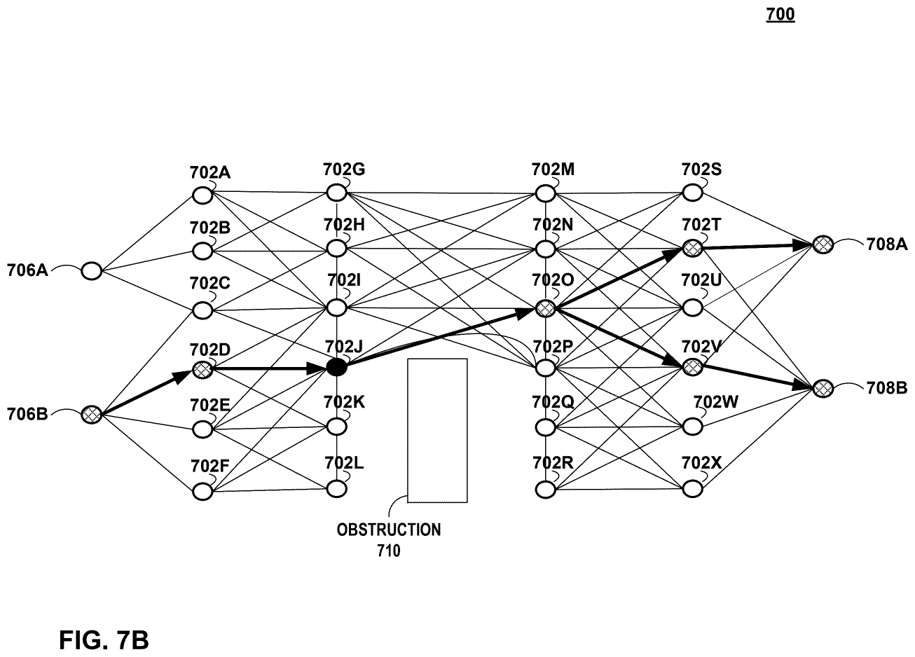

FIGS. 7A-7B are block diagrams illustrating an example graph model 700 associated with computing devices and cooling devices in a data center, in accordance with one or more aspects of the present disclosure. Graph model 700 may be an example of graph model 110 of FIGS. 2-3, for example. In some examples, nodes 702A-702X (“nodes 702”) in the graph model 700 represent rack fans or server fans in the data center facility that are each associated with (e.g., internal to a housing of) a different one of a plurality of computing devices and/or network devices in a data center space. Although not separately shown in the example of FIGS. 7A-7B for ease of illustration, the computing devices in the racks may also be represented as nodes in graph model 700. Cool air intake vents are represented by nodes 706A and 706B (intake vent nodes 706), while hot air exhaust vents are represented by nodes 708A and 708B (exhaust vent nodes 708).

In the example of FIG. 7A, nodes 702, 706, 708 are interconnected in various ways by corresponding edges. In an example, each of the edges has a length that represents an estimated physical distance that airflow must travel from one device node to another. If there is a physical obstruction between certain nodes that impedes airflow, such as obstruction 710 (e.g., a wall, an HVAC component of the data center, a cart), this may be represented as a longer edge between certain of the nodes, or by the absence of an edge between nodes. In some cases, edges may be pruned by where a given fan is observed to have a negligible effect on the airflow at another node, such as between fans at opposite sides of a room, or on opposite sides of an obstruction. A node can be also pruned from the graph if a server is removed from a rack, goes offline, or its fan stops functioning, as examples. A node can likewise be added to the graph when it is added to the network and detected by the controller. The controller may generate graph model 700 with an initial arrangement of nodes and edges based on server names or other provided information, but may subsequently update the graph model 700 by rearranging the relative arrangement and lengths of edges between nodes 702 in accordance with an updated understanding of the spatial arrangement of the nodes based on subsequently detected temperature data or other telemetry data.

Aspects of graph model 700 may also account for various constraints based on information such as present or predicted loads on each of the computing devices, current fan speeds, current temperature readings, edge lengths, and other information. Not all of the possible constraints or data points stored by graph model 700 are graphically depicted in FIG. 7A.

Temperature management module 32 can run a shortest path first algorithm on graph model 700 to determine a flow path from a given device/fan node to a given exhaust vent node. In the example of FIG. 7B, an overheating device is depicted by a dark shaded node 702J. Based on the shortest path first algorithm, temperature management module 32 selects a flow path including intake vent 706B, fan 702D, fan 702J, fan 702O, and a first branch to fan 702T to exhaust fan 708A. The flow path also includes an additional branch from fan 702O to fan 702V to exhaust fan 708B. In this example, the flow path is a point to multipoint path, in that it originates at one intake fan but terminates at two different exhaust fans. In this case, fan 702P is not along the shortest path because obstruction 710 causes the edge between fan 702O and fan 702P to have a greater value.

Based on the flow path determined by temperature management module 32, temperature management module 32 sends instructions to each of the fans 702 along the path to modify one or more operational parameters of the fans to effectuate the flow path, such as by increasing a fan speed of fans 702D, 702O, 702V, and 702T. Temperature management module 32 may also decrease a fan speed of fan 702J relative to its native/default setting (e.g., from high to medium), so that it is not working as hard, now that the other fans in the flow path are contributing to the effort of cooling the affected computing device.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The disclosures of all publications, patents, and patent applications referred to herein are hereby incorporated by reference. To the extent that any material that is incorporated by reference conflicts with the present disclosure, the present disclosure shall control.

For ease of illustration, only a limited number of devices are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each illustrate at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the Figures and/or may include additional devices and/or components not shown in the Figures.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium or media that can be used to store desired program code in the form of instructions or data structures and that can be accessed by a computer. However, the terms computer-readable storage media and data storage media do not include carrier waves, signals, or other transient media, but are instead directed to non-transient, tangible storage media.

Instructions may be executed by one or more processors, individually or collectively, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including, to the extent appropriate, a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

Where a phrase similar to “at least one of A, B, and C” is used in the claims, it is intended that the phrase be interpreted to mean that A alone may be present in an embodiment; B alone may be present in an embodiment; C alone may be present in an embodiment; or that any combination of the elements A, B, and C may be present in a single embodiment, for example, A and B, A and C, B and C, or A and B and C.

Where a phrase similar to “one or more processors configured to X, Y, and Z” is used in the claims, it is intended that the phrase be interpreted to mean at least: that a processor A alone may perform functions X, Y, and Z; that two or more processors (e.g., processors A and B) may collectively perform functions X, Y, and Z; that a first processor A may perform functions X and Y and a second processor may perform function Z; or that a first processor A may perform function X, a second processor may perform function Y, and a third processor may perform function Z.

Various examples have been described. These and other examples are within the scope of the following claims.

What is claimed is:

1. A system comprising:
storage media; and
processing circuitry having access to the memory and configured to:
obtain thermal metrics for a plurality of computing devices in a facility;
identify, based on the thermal metrics, a specific computing device of the plurality of computing devices that is at risk of overheating;
select, based on a model, one or more fans of a plurality of fans in the facility for which to adjust a parameter to address effects of overheating associated with the specific computing device, wherein the model represents a spatial arrangement of the plurality of computing devices and the plurality of fans in the facility, and wherein each of the plurality of fans is represented as a node in the model; and
send a control signal to adjust the parameter of the selected one or more fans.

2. The system of claim 1,
wherein, to select the one or more fans, the processing circuitry is configured to apply a Shortest Path First (SPF) algorithm to construct a flow path of air flowing through the plurality of computing devices, the flow path comprising at least two fans of the plurality of fans, and
wherein the selected one or more fans comprise the at least two fans.

3. The system of claim 2,
wherein the flow path further comprises an intake system, the specific computing device, and one or more exhaust vents,
wherein, the flow path is configured to transport air from the intake system, across the specific computing device, and toward the one or more exhaust vents, and
wherein, to send the control signal to adjust the parameter of the selected one or more fans, the processing circuitry is configured to increase a fan speed of the selected one or more fans.

4. The system of claim 1,
wherein the model comprises a graph model, and
wherein the processing circuitry is further configured to:
construct the graph model based on information received from the plurality of computing devices, wherein the graph model defines one or more constraints to be applied to the plurality of computing devices.

5. The system of claim 1,
wherein the model comprises a machine learning model, and
wherein the processing circuitry is further configured to:
train the machine learning model using at least some of the thermal metrics; and
apply the machine learning model to input data to make a prediction,
wherein the processing circuitry is configured to select the one or more fans based on the prediction from the machine learning model.

6. The system of claim 1, wherein the parameter comprises a fan speed.

7. The system of claim 1,
wherein the computing system comprises a centralized controller,
wherein the plurality of computing devices comprises a plurality of network devices, and
wherein each chassis of a plurality of chassis comprises two or more network devices of the plurality of network devices and two or more fans of the plurality of fans.

8. The system of claim 7, wherein, to obtain the thermal metrics, the processing circuitry is configured to obtain the thermal metrics from sensors placed at a plurality of locations on a corresponding chassis of each of the plurality of chassis.

9. The system of claim 7,
wherein the specific computing device comprises a network device of the plurality of network devices positioned in a first chassis of the plurality of chassis, and
wherein, to select the one or more fans, the processing circuitry is configured to select:
one or more fans of the plurality of fans positioned in the first chassis; or
one or more fans of the plurality of fans positioned in a second chassis of the plurality of chassis different than the first chassis.

10. The system of claim 1, wherein the processing circuitry is configured to select the one or more fans based on at least one of a current load or a forecasted demand of each of the plurality of computing devices, each computing device of the plurality of computing devices associated with one or more fans of the plurality of fans.

11. The system of claim 10, wherein, to select the one or more fans, the processing circuitry is configured to select one or more fans of the plurality of fans that are associated with one or more first computing devices, the one or more first computing devices having one or more of central processing unit (CPU) utilization, memory utilization, or bandwidth utilization that is currently or predicted to be lower than CPU utilization, memory utilization, or bandwidth utilization of one or more second computing devices of the plurality of computing devices.

12. The system of claim 1, wherein the processing circuitry is configured to select the one or more fans based on a real-time resource usage of each of the plurality of computing devices.

13. The system of claim 1, wherein, to select the one or more fans, the processing circuitry is configured to select one or more fans associated with one or more computing devices of the plurality of computing devices based on at least one of:
a predicted future load of the specific computing device, the predicted future load based on a pattern of one or more of peak times, incoming tasks, or scheduled events of the specific computing device; or
a potential future temperature increase of the specific computing device, the potential future temperature increase based on a workload pattern associated with the specific computing device.

14. A method comprising:
obtaining, by a computing system, thermal metrics for a plurality of computing devices in a facility;
identifying, by the computing system and based on the thermal metrics, a specific computing device of the plurality of computing devices that is at risk of overheating;
selecting, by the computing system and based on a model, one or more of a plurality of fans in the facility for which to adjust a parameter to address effects of overheating associated with the specific computing device, wherein the model represents a spatial arrangement of the plurality of computing devices and the plurality of fans in the facility, and wherein each of the plurality of fans is represented as a node in the model; and
sending, by the computing system, a control signal to adjust the parameter of the selected one or more fans.

15. The method of claim 14,
wherein selecting the one or more fans comprises applying a Shortest Path First (SPF) algorithm to construct a flow path of air flowing through the plurality of computing devices, the flow path comprising at least two fans of the plurality of fans, and
wherein the selected one or more fans comprise the at least two fans.

16. The method of claim 15,
wherein the flow path further comprises an intake system, the specific computing device, and one or more exhaust vents,
wherein, the flow path is configured to transport air from the intake system, across the specific computing device, and toward the one or more exhaust vents, and
wherein, to send the control signal to adjust the parameter of the selected one or more fans, the processing circuitry is configured to increase a fan speed of the selected one or more fans.

17. The method of claim 14,
wherein the model comprises a graph model, and
wherein method further comprises:
constructing, by the computing system, the graph model based on information received from the plurality of computing devices, wherein the graph model defines one or more constraints to be applied to the plurality of computing devices.

18. The method of claim 14,
wherein the model comprises a machine learning model, and
wherein method further comprises:
training, by the computing system, the machine learning model using at least some of the thermal metrics; and
applying, by the computing system, the machine learning model to input data to make a prediction, and
wherein selecting the one or more fans is based on the prediction from the machine learning model.

19. The method of claim 14,
wherein the computing system comprises a centralized controller,
wherein the plurality of computing devices comprise a plurality of network devices, and
wherein each chassis of a plurality of chassis comprises two or more network devices of the plurality of network devices and two or more fans of the plurality of fans.

20. Non-transitory, computer-readable storage media comprising instructions that, when executed by processing circuitry, cause a computing system to:
obtain thermal metrics for a plurality of computing devices in a facility;
identify, based on the thermal metrics, a specific computing device of the plurality of computing devices that is at risk of overheating;
select, based on a model, one or more fans of a plurality of fans in the facility for which to adjust a parameter to address effects of overheating associated with the specific computing device, wherein the model represents a spatial arrangement of the plurality of computing devices and the plurality of fans in the facility, and wherein each of the plurality of fans is represented as a node in the model; and
send a control signal to adjust the parameter of the selected one or more fans.
